(19) United States
(12) Patent Application Publication
(10) Pub. No.: US 2014/0156334 A1
(43) Pub. Date: Jun. 5, 2014

(54) SETTING CONSTRAINTS IN PROJECT PORTFOLIO OPTIMIZATION

(71) Applicant: INTERNATIONAL BUSINESS MACHINES CORP, Armonk, NY (US)

(72) Inventors: FAN JING MENG, BEIJING (CN); PERI LYNN TARR, YORKTOWN HEIGHTS, NY (US); XIN ZHOU, BEIJING (CN)

(73) Assignee: INTERNATIONAL BUSINESS MACHINES CORPORATION, Armonk, NY (US)

(21) Appl. No.: 13/693,856

(22) Filed: Dec. 4, 2012

(51) Int. Cl. G06Q 10/06

(52) U.S. Cl. CPC G06Q 10/06313
USPC 705/7.23

(57) ABSTRACT

A method for optimizing a project portfolio includes receiving initial objectives and constraints from a user. A portfolio optimization model is constructed based on the received initial objectives and constraints. The constructed portfolio optimization model is solved using an optimization engine executing on a computer system. A constraint optimization model is constructed based on the solved portfolio optimization model. The constraint optimization model is solved using the optimization engine. The portfolio optimization model is modified based on the solution to the constraint optimization model. The modified portfolio optimization model is solved. The solution to the modified portfolio optimization model is provided to the user.

### TECHNICAL FIELD

The present disclosure relates to portfolio optimization and more specifically to setting constraints in project portfolio optimization.

### DISCUSSION OF THE RELATED ART

A project portfolio is a set of projects that an organization chooses to pursue. Often, a portfolio manager is tasked with selecting projects to pursue and determining how to allocate funds and other scarce resources between projects within the project portfolio. These determinations are often made upon a cost-benefit analysis of all available project proposals. In the filed of information technology (IT) the task of portfolio management may be particularly difficult owing to complex interdependencies of projects.

For example, it may be difficult to determine how to allocate capital and programmers to improve a software suite including a word processor and an email client as improvements made to the word processor may enhance the usability of the email client and limitations of the email client may prevent various features of the word processor from being fully utilized.

While it may be relatively straightforward to understand how elements of the same software suite may be interdependent, in the modern landscape of platforms and ecosystems, complex interdependencies have developed between seemingly unrelated products and services such as the sale of books and tablet computers, the sale of music recordings and mobile phones, the selection of productivity software and cloud-storage.

Accordingly, because allocations to one project may affect not only that one project but may also affect other projects in a significant way, it may be particularly difficult for a portfolio manager to determine how best to allocate resources between the available projects. This difficulty has lead to portfolio managers to rely heavily on intuition and experience in making important decisions on asset allocation and project proposal selection.

### SUMMARY

A method for optimizing a project portfolio includes receiving initial objectives and constraints from a user. A portfolio optimization model is constructed based on the received initial objectives and constraints. The constructed portfolio optimization model is solved using an optimization engine executing on a computer system. A constraint optimization model is constructed based on the solved portfolio optimization model. The constraint optimization model is solved using the optimization engine. The portfolio optimization model is modified based on the solution to the constraint optimization model. The modified portfolio optimization model is solved. The solution to the modified portfolio optimization model is provided to the user.

The constraint optimization model may be constructed based on an adjustment, provided by the user, to an expected objective value or at least a part of the constraints.

The constructed portfolio optimization model results may be solved in the determination of an optimal portfolio optimization solution.

One or more values for the optimal portfolio optimization solution may be calculated after solving the constructed portfolio optimization model using an optimization engine executing on a computer system. The calculated values for the optimal portfolio optimization solution may be provided to the user. The user may be provided with an opportunity to modify the objectives or constraints based on the provided values for the solved portfolio optimization model.

A set of preferred objective values may be received from the user in response to providing the user the opportunity to modify the objectives. Tightened or released existing constraints may be received from the user in response to providing the user the opportunity to modify the constraints.

One or more sensitive constraints of the initial constraints received from the user may be automatically identified based on the solution to the constructed portfolio optimization model. The one or more identified sensitive constraints may be provided to the user. The user may be provided with an opportunity to modify the constraints based on the provided one or more identified sensitive constraints.

Prior to modifying the portfolio optimization model based on the solution to the constraint optimization model, the user may be provided with an opportunity to modify the objectives or constraints, and the portfolio optimization model may be modified based on the modified constraints in addition to the solution to the constraint optimization model.

Constructing the constraint optimization model based on the solved portfolio optimization model may include providing the user with the solution to the portfolio optimization model, providing the user with an opportunity to set alternative expected objective value or tighten/release existing constraints based on the provided solution to the portfolio optimization model, creating constraints for the constraint optimization model corresponding to expected portfolio objective value and unchanged constraints of the portfolio optimization model, as modified by the user, and creating objectives for the constraint optimization model corresponding to maximize tighten/minimize releasing of the constraints in portfolio optimization model, as modified by the user.

A method for optimizing a project portfolio includes receiving a portfolio optimization model based on objectives and constraints. A constraint optimization model is constructed based on the portfolio optimization model. The constraint optimization model is solved using an optimization engine executing on a computer system. The portfolio optimization model is modified based on the solution to the constraint optimization model and manual input provided by a user. The modified portfolio optimization model is solved. The solution to the modified portfolio optimization model is provided to the user.

The constraint optimization model may be constructed based on user input and the received portfolio optimization model. The received portfolio optimization model may be solved prior to the construction of the constraint optimization model and results of the solved received portfolio optimization model may result in the determination of an optimal portfolio optimization solution. The constraint optimization model may be constructed based on user input and the optimal portfolio optimization solution.

One or more values may be calculated for the optimal portfolio optimization solution after solving the constructed portfolio optimization model using an optimization engine executing on a computer system. The calculated values for the optimal portfolio optimization solution may be provided to the user. The user may be provided with an opportunity to modify the objectives or constraints based on the provided values for the solved portfolio optimization model.

A set of preferred objective values may be received from the user in response to providing the user the opportunity to modify the objectives. Tightened or released existing constraints may be received from the user in response to providing the user the opportunity to modify the constraints.

Prior to modifying the portfolio optimization model based on the solution to the constraint optimization model, the user may be provided with an opportunity to modify the objectives or constraints, and the portfolio optimization model may be modified based on the modified constraints in addition to the solution to the constraint optimization model.

A method for optimizing a project portfolio includes receiving a portfolio optimization model based on objectives and constraints. Adjustments to an expected objective value of the objective values or at least a part of the constraints are received form the user. A constraint optimization model is constructed based on the portfolio optimization model and the adjustments received by the user. The constraint optimization model is solved using an optimization engine executing on a computer system to determine an optimal portfolio optimization solution. The portfolio optimization model is modified based on the optimal portfolio optimization solution. The modified portfolio optimization model is solved. The solution to the modified portfolio optimization model is outputted.

One or more values for the optimal portfolio optimization solution may be calculated after solving the constructed portfolio optimization model. The calculated values for the optimal portfolio optimization solution may be provided to the user The user may be provided with an opportunity to modify the objectives or constraints based on the provided values for the solved portfolio optimization model.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a flow chart illustrating an approach for portfolio optimization in accordance with exemplary embodiments of the present invention;

FIG. 2 is a flow chart illustrating an approach for building a constraint optimization model in accordance with exemplary embodiments of the present invention;

FIG. 3 is a block diagram illustrating a system for performing portfolio optimization in accordance with exemplary embodiments of the present invention; and

FIG. 4 shows an example of a computer system capable of implementing the method and apparatus according to embodiments of the present disclosure.

### DETAILED DESCRIPTION OF THE DRAWINGS

In describing exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Exemplary embodiments of the present invention provide methods and systems for performing automated project portfolio optimization so that project portfolio managers may be aided in determining asset allocation and project proposal selection. Approaches for automated project portfolio optimization in accordance with exemplary embodiments of the present invention may include a constraint optimization process where the criteria by which portfolio optimization is performed may be adjusted.

Project portfolio optimization involves the analysis of available assets, available projects and project proposals, and the complex interdependencies between the available projects and proposals. The result of this analysis is to determine an optimum asset allocation among the projects and proposals that provides the highest probability of obtaining a maximum net present value (NPV) for the portfolio, given the supplied facts and assumptions. In addition to providing an optimum allocation, project portfolio optimization may provide an estimate for NPV for a best-case, a worst-case, and a most-likely case as these values may be beneficial in building a desired portfolio.

Exemplary embodiments of the present invention automate the process of project portfolio optimization and introduce the concept of selected constraints into the analysis. As computer modeling may be used to calculate an expected NPV for the portfolio given all possible variations of asset allocation, constraints may play a significant role in reducing the computational complexity of the model and in reducing impractical or otherwise useless results.

Constraints may define the set of available resources and outcomes necessary to justify the efforts. Moreover, constraints may define the extent of flexibility for each project or proposal and the nature of interdependency between projects and proposals. For example, a constraint may be set limiting the total available budget for the project portfolio to a particular dollar amount. A constraint may be to define a minimum. NPV that must be realized in order to justify the budget expenditure. A constraint may be to establish a total number of programmers that may be allocated between projects. A constraint may be to establish when a project must be completed by. A constraint may be to establish when a component of one project is a necessary prerequisite for another project or to define the conditions in which a project must be halted.

In this context, constraints are bounds placed on the computer model. Having too few constraints may lead to incalculable model complexity while having too many constraints may lead to the under-inclusion of meaningful options.

Exemplary embodiments of the present invention may provide a system and method by which the portfolio manager may model the projects, proposals and constraints and then initiate an automated analysis to produce one or more optimized asset allocations. Thereafter, the portfolio manager may engage in an iterative process by which the constraints are modified and the optimization repeated. In this way, the portfolio manager may explore different portfolio constraining approaches to achieve the same portfolio objective. Moreover, as objectives change, the portfolio manager may utilize exemplary embodiments of the present invention to meet tightened and/or relaxed portfolio constraints within the project portfolio optimization model.

Moreover, exemplary embodiments of the present invention may model the constraints and then optimize the model so the manually provided constraints may themselves be optimized. For example, after exemplary embodiments of the present invention determine an optimum project portfolio given the provided constraints, various changes to the provided constraints may be automatically determined and proposed. In so doing, various blocker constraints and other sensitive constraints may be identified.

In the filed of project portfolio management, it may be difficult to determine which constraints serve as blocker constraints, which are constraints that prevent a better project portfolio from being selected. For example, it may be the case that a 10% increase in portfolio budget may, with the correctly optimized portfolio, result in a 30% increase in portfolio NPV. If no other changes to portfolio arrangement or constraints could produce the 30% increase then the budget may be identified as a blocker constraint.

Moreover, even in the absence of any single blocker constraint, relaxing one or more constraints may produce an uncharacteristically high improvement in portfolio outcome. Such constraints may be identified as sensitive constraints as their relaxation and/or tightening may produce a significant change in portfolio value.

By optimizing constraints, exemplary embodiments may go beyond merely finding the ideal project portfolio for a given set of constraints, and may suggest changes to the constraints themselves. In this way, exemplary embodiments of the present invention not only provide the best solution for a given set of rules, but also determine how the rules may be changed to provide an even better solution.

Moreover, by optimizing constraints, exemplary embodiments of the present invention may be able to tighten constraints where it is determined that the marginal resource outlay established by the user-provided constraints is not necessarily justified by the benefit provided thereby. For example, where a provided constraint is a team of ten engineers and an allotted time frame of 12 months, constraint optimization might not only determine that relaxing the time constraint to 14 months would provide a significantly greater result then leaving the time constraint at 12 months, but constraint optimization might also determine that a team of eight engineers may provide a substantially comparable outcome to the allotment of ten engineers, in which case constraint tightening may be suggested.

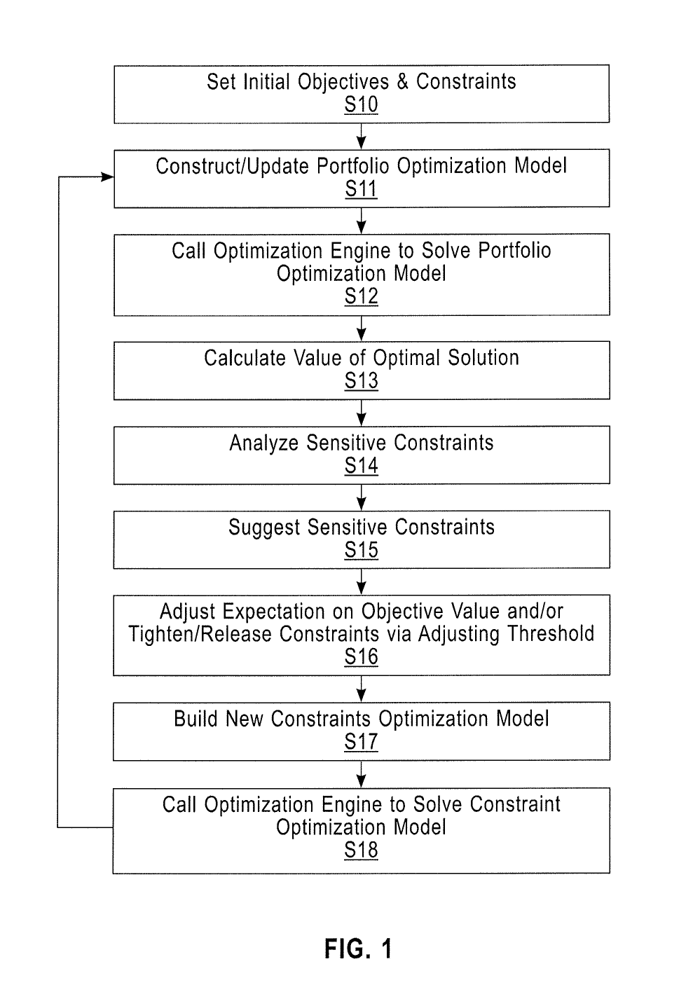

FIG. 1 is a flow chart illustrating an approach for portfolio optimization in accordance with exemplary embodiments of the present invention. First, an initial set of objectives and constraints may be provided (Step S10). The initial set of objectives and constraints may be manually provided. Objectives may include a set of desired outcomes for the project portfolio such as minimum NPV, market penetration, etc. While constraints may represent a fixed goal, such as to obtain an at least 20% market share, objectives may be open-ended, such as to maximize NPV or to minimize money spent. Thus, satisfaction of an objective is a matter of degree. Constraints may include a set of limitations imposed on the project portfolio such as budget constraints, personnel, timeframes, regulatory/industry compliance, etc.

From the supplied constraints and objectives, exemplary embodiments of the present invention may construct a portfolio optimization model (Step SI 1). The portfolio optimization model may be a computer model of possible project portfolios, including fixed values as constants and unknown and/or changeable values as variables. The portfolio optimization model may mathematically represent relationships between the constraints, the objectives, and the projects that may achieve the objectives within the constraints.

Thereafter, an optimization engine may be executed to solve the portfolio optimization model (Step S12). Optimization may include iteratively changing the project portfolio solution and monitoring a measure of a degree to which the portfolio solution is expected to satisfy the provided objectives. As objectives may be open-ended, optimization may not necessarily be a determination of how to satisfy the objectives while staying within the constraints, but may be a determination of what project portfolio solution is most likely to provide the highest degree of objective satisfaction. For example, where an objective is to maximize NPV, an optimal portfolio solution may provide the highest expected NPV.

As optimization may take into account the most probable outcome along with a best-case outcome and a worst-case outcome, objectives and constraints may be provided based on any of these modeled outcomes. For example, an objective may be to maximize best-case NPV outcome. For example, a constraint may be to keep worst-case environmental impact within a particular threshold.

Optimization may be performed, for example, by executing an optimization engine, for example, ILOG Optimization & Analytical Decision Support Solutions provided by IBM. The optimization engine may take as input, the portfolio optimization model.

After the optimization of the portfolio optimization model has been completed and an optimal solution obtained, values for the optimal solution may be calculated and presented to a user (Step S13). The values may include a quantification of the best-case outcome, the worst-case outcome, and/or an expected outcome. The user may view these values and may make a determination as to whether the calculated optimal solution is acceptable.

Where the portfolio manager desires to achieve better outcome by releasing constraints or wishes to adjust constraints without affecting the outcome, exemplary embodiments of the present invention may be used to propose changes to the constraints themselves. This may include the performance of a sensitive constraint analysis (Step S14). In this step, exemplary embodiments of the present invention may determine which of the provided constraints are sensitive. A sensitive constraint is a constraint that, if relaxed, would provide a substantive improvement to objective satisfaction. A constraint is not sensitive if its relaxation would have little to no impact on objective satisfaction.

Sensitive constraint analysis may include a systematic relaxation of constraints followed by a calculated determination of the outcome. This may be accomplished by relaxing constraints one-at-a-time. However, as constraints may be interdependent, sensitive constraint analysis may also include relaxing constraints in pairs or groups.

As an alternative to finding sensitive constraints by systematic trial, exemplary embodiments of the present invention may determine sensitive constraints by analyzing the portfolio model directly.

Once one or more sensitive constraints have been identified, the sensitive constraints may be presented to the user (Step S15). As not all sensitive constraints may be relaxable, the user may be provided with an opportunity to review the sensitive constraints so that sensitive constraints that may not be relaxed can be manually removed from further analysis. The user may also be provided with an opportunity to identify additional constraints as sensitive or to otherwise approve or modify a listing of sensitive constraints.

Accordingly, the user may be provided with an opportunity to adjust expectations for the objective values and/or tighten/release constraints (Step S16). The tightening and/or release of constraints may be performed, for example, by adjusting threshold values. By adjusting expectations for the objective values, the user may change constraints. This may be performed, for example, in response to the suggestion of sensitive constraints. For example, if it is suggested that budget is a sensitive constraint, the user may wish to take the opportunity provided at this step to increase the threshold of the budget to allow for the allocation of additional monetary resources. Similarly, if the system fails to identify personnel allocation as a sensitive constraint, the user may wish to take the opportunity provided at this step to reduce the threshold of the personnel allocation so that fewer people may be allocated to the projects of the portfolio.

Thereafter, a new constraint optimization model may be constructed from the adjusted expectations, to the extent that expectations on objective values and/or constraints are tightened/released (Step S17). The solution, obtained by solving the new constraint optimization model, may therefore be a refinement of the originally constructed portfolio model of Step S11.

Exemplary embodiments of the present invention may thereafter solve the constraint optimization model (Step S17). This may be performed, for example, by running an optimization engine on the constraint optimization model.

Thus, optimization may be performed, for example, by executing an optimization engine, for example, ILOG Optimization & Analytical Decision Support Solutions provided by IBM. The optimization engine may take as input, the constraint optimization model. The output of this optimization may be an optimal constraint solution, which may represent how to relax and/or tighten constraints to best enhance satisfaction of objectives. The optimization constraint solution may be used to modify/update the portfolio optimization model (Step S11).

The user may also be provided with an opportunity to set new expectation on objective values and/or release/tighten constraints, (e.g. relaxing or tightening thresholds on constraint values). These adjustments may also be included in the constraint optimization model that is optimized to find the optimization constraint solution.

In a process that may be called portfolio re-optimization, the portfolio optimization model may be refined with the optimal constraint solution, for example, at a repeat of Step S11. The optimization engine may be called again (Step 512) and the refined portfolio optimization model may be solved to fine another optimal portfolio solution (Step S13). The process may be iterative and portfolio optimization may be repeated, for example, until the user is satisfied with the results.

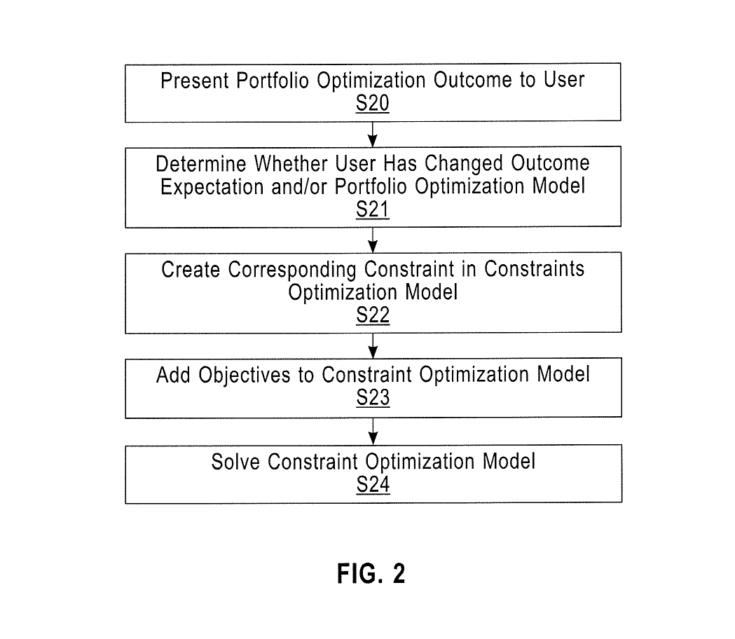

FIG. 2 is a flow chart illustrating an approach for building a constraint optimization model in accordance with exemplary embodiments of the present invention. As discussed above, by solving a constraint model, exemplary embodiments of the present invention may facilitate the modification of constraints to further improve portfolio model outcome beyond simply optimizing the portfolio model given the set of provided constraints.

First, the outcome of the portfolio model optimization may be presented to a user (Step S20). The user may thereafter determine whether to modify the parameters of the portfolio model. Here, the user may be provided with an opportunity to manually change parameters such as constraint, for example, by relaxing and/or tightening constraints thresholds. The system may then determine whether the user has modified the portfolio model parameters (Step S21). Where it is determined that the user has relaxed/tightened constraints within the portfolio model, a corresponding constraint may be added to a constraint optimization model, which may be formed thereby (Step S22). Additional constraints may be created within the constraint optimization model by copying each of the portfolio optimization constraints without a new threshold that has been raised by the user and decision variables may be defined within the constraint optimization model corresponding to the thresholds of the created constraints.

One or more objectives may then be created within the constraint optimization model for the constraints with the new threshold (Step S23). This may include, for example, a maximization of the constraint tightening where the user raises or lowers expected values or minimizes constraint relaxation where the user raises expected objective values higher. The constraint optimization model may thereafter be solved to determine an optimal constraint solution and the resulting optimal constraint solution may be incorporated within the project model to enhance optimization of the project model (Strep S24). The constraint optimization model may be solved, for example, using an optimization engine, for example, the same optimization engine used to solve the portfolio optimization model discussed above.

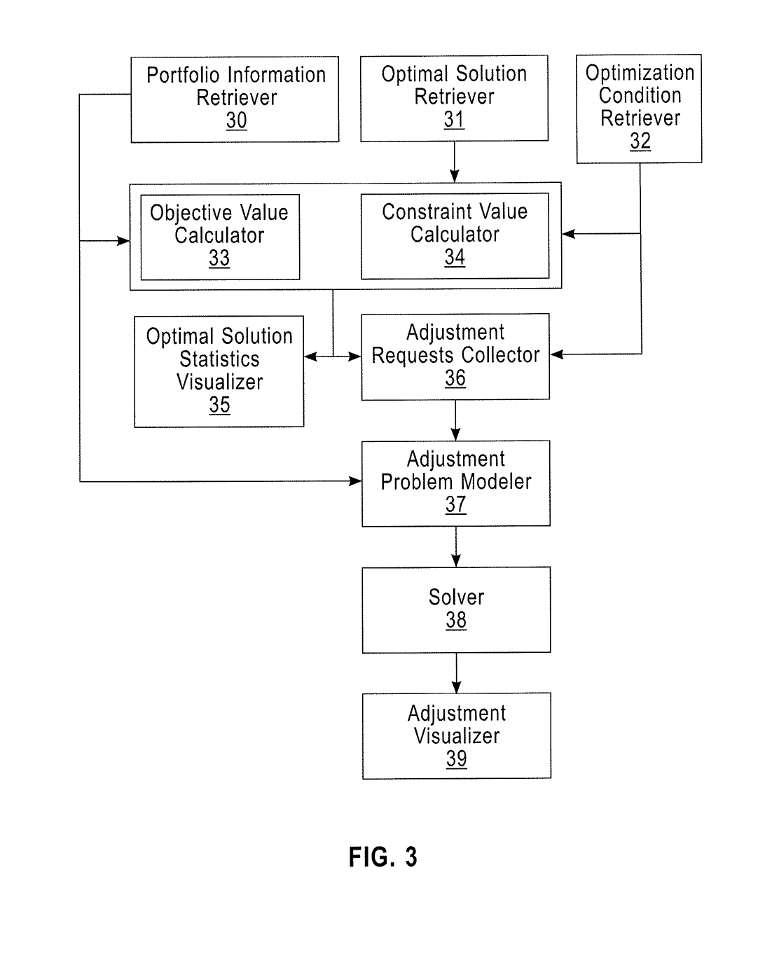

FIG. 3 is a block diagram illustrating a system for performing portfolio optimization in accordance with exemplary embodiments of the present invention. Each item illustrated herein may be embodied by a computer system executing code to provide the described function. A portfolio information retriever 30 may retrieve information pertaining to the project portfolio such as proposals, relationships, etc. Similarly, an optimal solution retriever 31 may retrieve information pertaining to an optimized project portfolio solution. Similarly, an optimization conditions retriever 32 may retrieve information pertaining to conditions and/or parameters of the portfolio optimization model, such as objectives and constraints.

The information retrieved from the retrievers 30-32 may be provided to an objective value calculator 33 and a constraint value calculator 34. The object value calculator 33 may utilize the retrieved information and may calculate the value of attributes related to objectives for a solution. For example, the object value calculator 33 may calculate the ROI for a given solution. Similarly, the constraint value calculator 34 may calculate the value of attributes related to the constraints for a solution. For example, the constraint value calculator 34 may calculate a total cost for a given solution, which may be related to a budget constraint.

An optimal solution statistics visualizer 35 and an adjustment requests collector 36 may receive the calculated objective values and the calculated constraint values. The optimal solution statistics visualizer 35 may gather statistics pertaining to the optimal solution and prepare the statistics for presentation to the user so that the user can better understand the outcome predictions for the optimal solution. The adjustment requests collector 36 may additionally receive the optimal conditions and may accept user-provided requests for changes to the project objectives and/or constraints.

User-provided changes and the retrieved portfolio information may be received by an adjustment problem modeler 37. The adjustment problem modeler 37 may then modify the portfolio model accordingly. A solver 38 may perform the portfolio model optimization and an adjustment visualizer 39 may provide the user with a readily-understandable display of the new optimal portfolio solution.

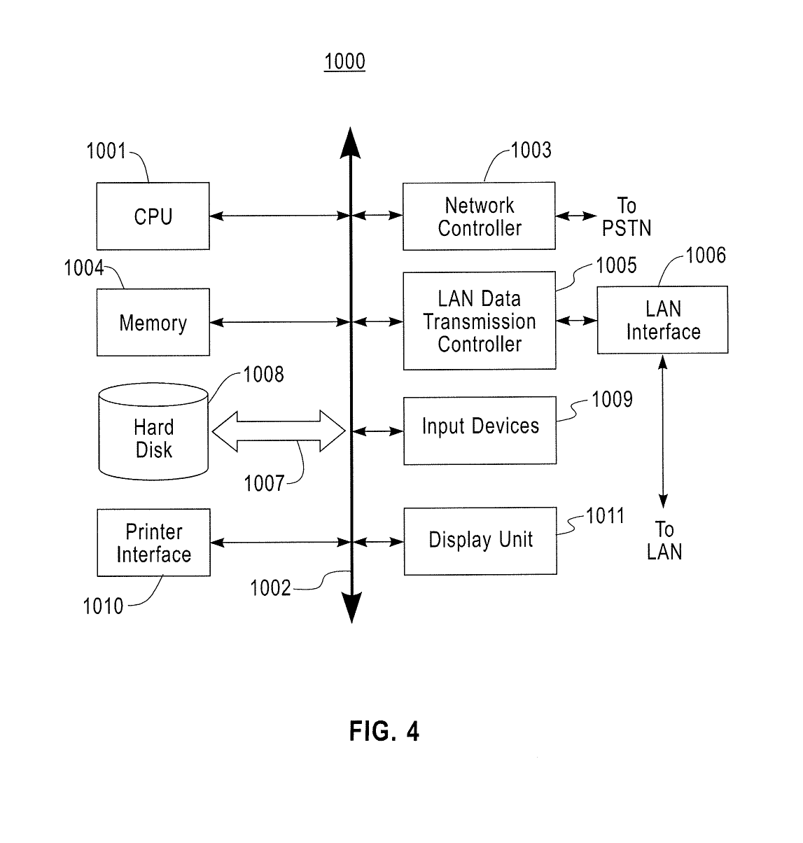

FIG. 4 shows an example of a computer system which may implement a method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

What is claimed is:

1. A method for optimizing a project portfolio, comprising:
receiving initial objectives and constraints from a user;
constructing a portfolio optimization model based on the received initial objectives and constraints;
solving the constructed portfolio optimization model using an optimization engine executing on a computer system;
constructing a constraint optimization model based on the solved portfolio optimization model;
solving the constraint optimization model using the optimization engine;
modifying the portfolio optimization model based on the solution to the constraint optimization model;
solving the modified portfolio optimization model; and
providing the solution to the modified portfolio optimization model to the user.

2. The method of claim 1, wherein the constraint optimization model is constructed based on an adjustment, provided by the user, to an expected objective value or at least a part of the constraints.

3. The method of claim 1, wherein solving the constructed portfolio optimization model results in the determination of an optimal portfolio optimization solution.

4. The method of claim 3, additionally comprising:
calculating one or more values for the optimal portfolio optimization solution after solving the constructed portfolio optimization model using an optimization engine executing on a computer system;
providing the calculated values for the optimal portfolio optimization solution to the user; and
providing the user an opportunity to modify the objectives or constraints based on the provided values for the solved portfolio optimization model.

5. The method of claim 4, a set of preferred objective values is received from the user in response to providing the user the opportunity to modify the objectives.

6. The method of claim 4, wherein tightened or released existing constraints are received from the user in response to providing the user the opportunity to modify the constraints.

7. The method of claim 1, additionally comprising:
automatically identifying one or more sensitive constraints of the initial constraints received from the user based on the solution to the constructed portfolio optimization model;
providing the one or more identified sensitive constraints to the user; and
providing the user an opportunity to modify the constraints based on the provided one or more identified sensitive constraints.

8. The method of claim 1, wherein prior to modifying the portfolio optimization model based on the solution to the constraint optimization model, the user is provided with an opportunity to modify the objectives or constraints, and the portfolio optimization model is modified based on the modified constraints in addition to the solution to the constraint optimization model.

9. The method of claim 1, wherein constructing the constraint optimization model based on the solved portfolio optimization model, comprises:
providing the user with the solution to the portfolio optimization model;
providing the user with an opportunity to set alternative expected objective value or tighten/release existing constraints based on the provided solution to the portfolio optimization model;
creating constraints for the constraint optimization model corresponding to expected portfolio objective value and unchanged constraints of the portfolio optimization model, as modified by the user; and
creating objectives for the constraint optimization model corresponding to maximize tighten/minimize releasing of the constraints in portfolio optimization model, as modified by the user.

10. A method for optimizing a project portfolio, comprising:
receiving a portfolio optimization model based on objectives and constraints;
constructing a constraint optimization model based on the portfolio optimization model;
solving the constraint optimization model using an optimization engine executing on a computer system;
modifying the portfolio optimization model based on the solution to the constraint optimization model and manual input provided by a user;
solving the modified portfolio optimization model; and
providing the solution to the modified portfolio optimization model to the user.

12. The method of claim 11, wherein the constraint optimization model is constructed based on user input and the received portfolio optimization model.

13. The method of claim 11, wherein the received portfolio optimization model is solved prior to the construction of the constraint optimization model and results of the solved received portfolio optimization model result in the determination of an optimal portfolio optimization solution.

14. The method of claim 13, wherein the constraint optimization model is constructed based on user input and the optimal portfolio optimization solution.

15. The method of claim 13, additionally comprising:
calculating one or more values for the optimal portfolio optimization solution after solving the constructed portfolio optimization model using an optimization engine executing on a computer system;
providing the calculated values for the optimal portfolio optimization solution to the user; and
providing the user an opportunity to modify the objectives or constraints based on the provided values for the solved portfolio optimization model.

16. The method of claim 15, a set of preferred objective values is received from the user in response to providing the user the opportunity to modify the objectives.

17. The method of claim 15, wherein tightened or released existing constraints are received from the user in response to providing the user the opportunity to modify the constraints.

18. The method of claim 11, wherein prior to modifying the portfolio optimization model based on the solution to the constraint optimization model, the user is provided with an opportunity to modify the objectives or constraints, and the portfolio optimization model is modified based on the modified constraints in addition to the solution to the constraint optimization model.

19. A method for optimizing a project portfolio, comprising:
receiving a portfolio optimization model based on objectives and constraints;
receiving, from a user, adjustments to an expected objective value of the objective values or at least a part of the constraints;
constructing a constraint optimization model based on the portfolio optimization model and the adjustments received by the user;
solving the constraint optimization model using an optimization engine executing on a computer system to determine an optimal portfolio optimization solution;
modifying the portfolio optimization model based on the optimal portfolio optimization solution;
solving the modified portfolio optimization model; and
outputting the solution to the modified portfolio optimization model.

20. The method of claim 19, wherein one or more values for the optimal portfolio optimization solution are calculated after solving the constructed portfolio optimization model, the calculated values for the optimal portfolio optimization solution are provided to the user, and the user is provided with an opportunity to modify the objectives or constraints based on the provided values for the solved portfolio optimization model.
